(19) United States
(12) Patent Application Publication
(10) Pub. No.: US 2024/0279918 A1
(43) Pub. Date: Aug. 22, 2024

(54) ADAPTING SUPPORT BEAM WHEEL

(71) Applicant: A&C FUTURE, INC., Newport Beach, CA (US)

(72) Inventors: Xunmin Jiang, Irvine, CA (US); Sichen Li, Santa Ana, CA (US); Zhuangboyu Zhou, Santa Ana, CA (US); Jiuqi Wang, Santa Ana, CA (US); Shoue CHEN, Irvine, CA (US); Ju Gao, Newport Beach, CA (US); Pengcheng Wang, Irvine, CA (US); Han Qin, Newport Beach, CA (US); Jiayang Qin, Newport Beach, CA (US)

(21) Appl. No.: 18/172,947

(22) Filed: Feb. 22, 2023

(51) Int. Cl. E04B 1/343; E04G 21/18

(52) U.S. Cl. CPC E04B 1/34352; E04G 21/1841

(57) ABSTRACT

An adaptive support supports an expandable mobile house during and after expansion thereof. The adaptive support can be used on modular house to serve as support when deployed. The mechanism includes a static support beam and two support wheel that can be used interchangeably. The adaptive support can also be manufactured without the wheels when the house only needs static support. The mechanism can be retracted so it does not hinder the transportation of the mobile house. The adaptive support can adapt to an uneven terrain. A pressure sensor embedded in the support allows it to nullify the bumps on the ground during expansion of a mobile house using the wheels as support. A gyroscope sensor can be used to balance the house to be flat on sloped ground. If deployed on an artificial flat surface, the adapting system can be deactivated so it serves like a regular support beam.

### BACKGROUND OF THE INVENTION

### 1. Field of the Invention

Embodiments of the invention relate generally to a support system. More particularly, embodiments of the invention relate to a wheeled support system that can adapt to uneven terrain when an expansion section is expanded and retracted.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

When a user wants to place their mobile house in the field or the like, expansion of expansion sections may be difficult when trying to move the expansion section over uneven terrain. Further, once deployed, a user often has to manually adjust any supports to adequately support the expansion section.

In view of the foregoing, there is a need for a support system that can adapt automatically while moving over uneven terrain.

### SUMMARY OF THE INVENTION

Embodiments of the present invention aim to solve the aforementioned problems in conventional supports by providing s support system that may read a pressure exerted by the support and automatically adjust a height of the support based on the detected pressure.

Embodiments of the present invention provide a support for a structure, comprising a rotatable internally threaded shell; a threaded shaft having external threads mating with internal threads of the rotatable internally threaded shell; one or more wheels supporting the threaded shaft; and a pressure sensor operable to measure a force exerted on the threaded shaft by the structure, the pressure sensor operable to drive the rotatable internally threaded shell to maintain the measured force between a predetermined range while the support is moved along its one or more wheels.

Embodiments of the present invention provide a support for a structure, comprising a rotatable internally threaded shell; a threaded shaft having external threads mating with internal threads of the rotatable internally threaded shell; a threaded shell motor operable to drive the rotatable internally threaded shell; a pressure sensor operable to measure a force exerted on the threaded shaft by the structure; and a microcontroller receiving data from the pressure sensor, the microcontroller operable to drive the rotatable internally threaded shell to maintain the measured force between a predetermined range.

Embodiments of the present invention provide a support for a structure, comprising a rotatable internally threaded shell; a threaded shaft having external threads mating with internal threads of the rotatable internally threaded shell; one or more wheels supporting the threaded shaft; a pressure sensor operable to measure a force exerted on the threaded shaft by the structure, the pressure sensor operable to drive the rotatable internally threaded shell to maintain the measured force between a predetermined range while the support is moved along its one or more wheels; a support beam receiving a lower end of the threaded shaft; a beam shell housing the support beam, the beam shell having a wheel axle passing therethrough; and a lock ring fixing the support beam to the beam shell, wherein turning the lock ring permits downward extension of the support beam relative to the beam shell.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1A illustrates a perspective view of an adaptive support according to an exemplary embodiment of the present invention;

FIG. 1B illustrates a bottom view of the adaptive support of FIG. 1A;

FIG. 1C illustrates a front view of the adaptive support of FIG. 1A;

FIG. 1D illustrates a side view of the adaptive support of FIG. 1A;

FIG. 2A illustrates a front view of the adaptive support with support beam wheel extended;

FIG. 2B illustrates a perspective view of the adaptive support of FIG. 2A;

FIG. 3A illustrates a perspective view of a lowerable support beam according to an exemplary embodiment of the present invention;

FIG. 3B illustrates a bottom view of the lowerable support beam of FIG. 3A;

FIG. 3C illustrates a front view of the lowerable support beam of FIG. 3A;

FIG. 3D illustrates a side view of the lowerable support beam of FIG. 3A;

FIG. 4A illustrates a perspective view of a beam shell for holding wheels according to an exemplary embodiment of the present invention;

FIG. 4B illustrates a bottom view of the beam shell of FIG. 4A;

FIG. 4C illustrates a front view of the beam shell of FIG. 4A;

FIG. 4D illustrates a side view of the beam shell of FIG. 4A;

FIG. 5A illustrates a side view of the beam shell of FIG. 4A;

FIG. 5B illustrates a side cross-sectional view of the beam shell of FIG. 5A;

FIG. 5C illustrates a perspective wireframe view of the beam shell of FIG. 4A;

FIG. 5D illustrates a cross-sectional view of the beam shell of FIG. 5C;

FIG. 6A illustrates a cut-away view of a threaded shaft shell of the adaptive support of FIG. 1A;

FIG. 6B illustrates a top view of the threaded shaft shell of FIG. 6A;

FIG. 6C illustrates a front view of the threaded shaft shell of FIG. 6A;

FIG. 6D illustrates a side view of the threaded shaft shell of FIG. 6A;

FIG. 7A illustrates a perspective view of a locking ring according to an exemplary embodiment of the present invention;

FIG. 7B illustrates a bottom view of the locking ring of FIG. 7A;

FIG. 7C illustrates a front view of the locking ring of FIG. 7A;

FIG. 7D illustrates a side view of the locking ring of FIG. 7A;

FIG. 8A illustrates a perspective view of a threaded shaft according to an exemplary embodiment of the present invention;

FIG. 8B illustrates a bottom view of the threaded shaft of FIG. 8A;

FIG. 8C illustrates a front view of the threaded shaft of FIG. 8A;

FIG. 8D illustrates a side view of the threaded shaft of FIG. 8A;

FIG. 9 illustrates a perspective view of a pressure sensor usable in the adaptive support of FIG. 1A;

FIG. 10A illustrates an exploded perspective view of an adaptive support according to an exemplary embodiment of the present invention;

FIG. 10B illustrates an exploded bottom view of the adaptive support of FIG. 10A;

FIG. 10C illustrates an exploded front view of the adaptive support of FIG. 10A;

FIG. 10D illustrates an exploded side view of the adaptive support of FIG. 10A;

FIG. 11 illustrates a front view of the adaptive support of FIG. 1A, showing the motion for lowering the support beam after expansion;

FIG. 12A illustrates a front view of the support beam of the adaptive support of FIG. 1A ready to be lowered;

FIG. 12B illustrates a front view showing the motion for unlocking the support beam of the adaptive support of FIG. 1A to allow it to be lowered;

FIG. 12C illustrates a cross-sectional view taken along line B-B of FIG. 12A;

FIG. 12D illustrates a cross-sectional view taken along line A-A of FIG. 12A;

FIG. 13A illustrates a perspective view of the support beam without wheels according to an exemplary embodiment of the present invention;

FIG. 13B illustrates a bottom view of the support beam of FIG. 13A;

FIG. 13C illustrates a front view of the support beam of FIG. 13A;

FIG. 13D illustrates a side view of the support beam of FIG. 13A;

FIG. 14 illustrates a block diagram showing operation of the adaptive support of FIG. 1A, with a passive wheel system, according to an exemplary embodiment of the present invention;

FIG. 15 illustrates a block diagram showing operation of the adaptive support of FIG. 1A, with an active wheel system, according to an exemplary embodiment of the present invention;

FIG. 16A illustrates a side view of an expansion section before leveling;

FIG. 16B illustrates a side view of the expansion section of FIG. 16A, after leveling with the adaptive support of FIG. 1A; and

FIG. 17 illustrates a block diagram showing operation of a terrain adapting system according to an exemplary embodiment of the present invention.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an adaptive support for supporting an expandable mobile house during expansion and after expansion has finished. The adaptive support can also be used on modular house to serve as support when deployed. The mechanism includes a static support beam and two support wheel that can be used interchangeably. The adaptive support can also be manufactured without the wheels when the house only needs static support. The mechanism can be retracted so it does not hinder the transportation of the mobile house. The adaptive support can adapt to an uneven terrain. A pressure sensor embedded in the support allows it to nullify the bumps on the ground during expansion of a mobile house using the wheels as support. A gyroscope sensor can be used to balance the house to be flat on sloped ground. If deployed on an artificial flat surface, the adapting system can be deactivated so it serves like a regular support beam.

The figures are briefly described below, followed by a broader discussion of each figure and the components therein.

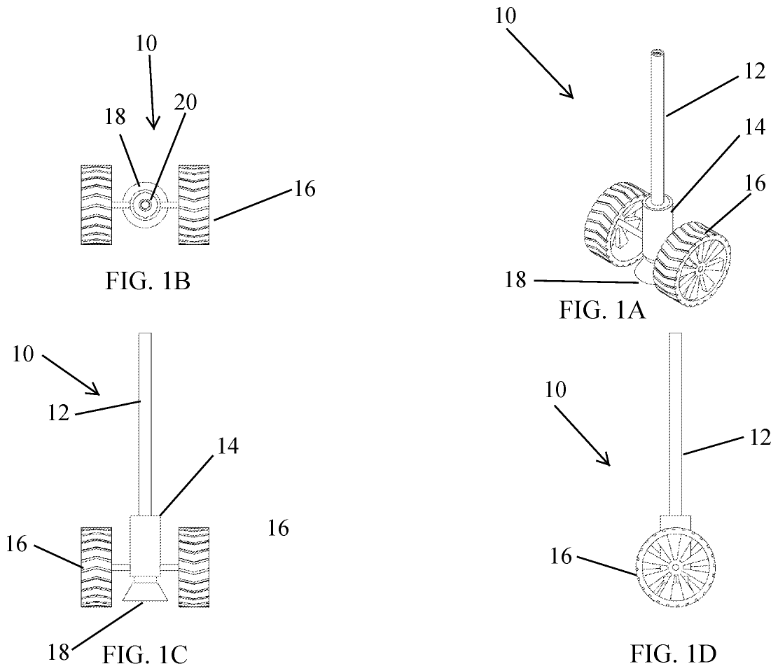

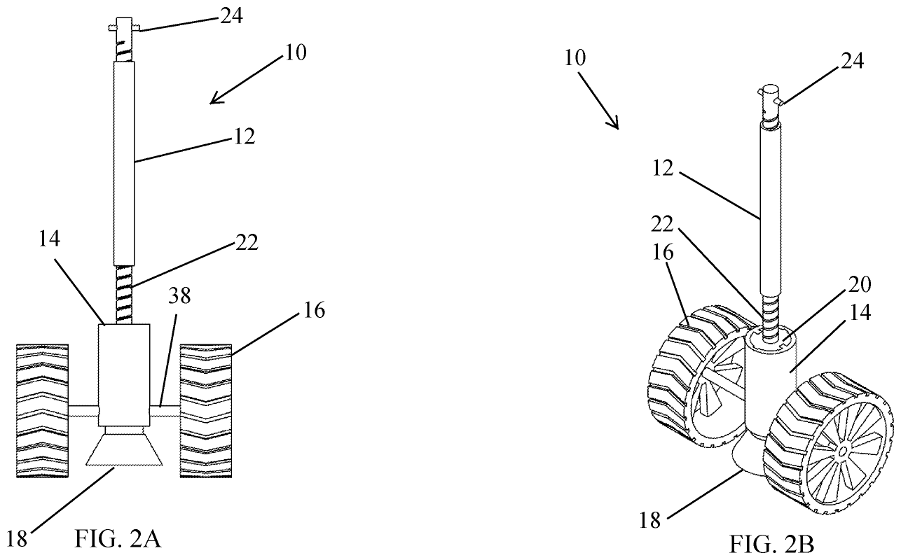

FIGS. 1A through 2B show an overview of the support beam wheel design. The mechanism includes a rotatable threaded cylindrical shell at the top, a threaded shaft inside of the cylindrical shell, and a support beam and wheel at the bottom. The cylindrical shell can be powered by an electric motor to extend or retract the threaded shaft inside the shell. By extending the shaft, the mechanism, besides the threaded shell, is changed in its height, and the wheel or the support beam can provide support to the mobile house it is on. When the mobile house is fully retracted, the mechanism can also be retracted to a significant height above the ground, so it will not affect the mobile house when it is on road. The wheel of the mechanism is for providing support when the mobile house is in the expansion or retraction process, and the support beam is for providing support when the mobile house is fully expanded. The mechanism has a pressure sensor to read the pressure the entire mechanism is supporting A microcontroller can adjust the height of each of the supports according to the pressure exerted. The microcontroller can then balance the mobile house on an uneven terrain.

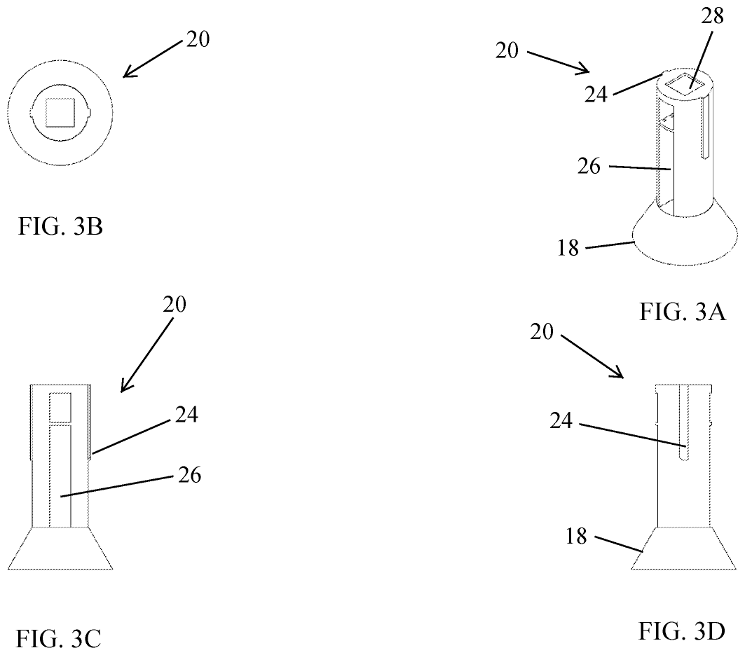

FIGS. 3A through 3D show the support beam of the mechanism. The support beam is only lowered when the expansion process is finished. The support beam has a rectangular protrusions on two opposite sides to prevent rotation between the support beam and the outer shell, which is connected to the wheels. These protrusions also serve as the pins that can lock the support beam from moving down. The top of the support beam can house a pressure sensor for measuring the force applied onto the support beam or wheel, since all the normal force applied to the mechanism goes through the support beam. The center of the support beam can be hollowed to ensure vertical motion of the support beam is not prohibited by the shaft that connects the two wheels. The upper center of the support beam can house some fluid to achieve a damping effect. The fluid can flow through the small holes on the thin surface at the center of the support beam to slow down the jolting motion of support beam coming down when the locking ring is unlocked, as described below.

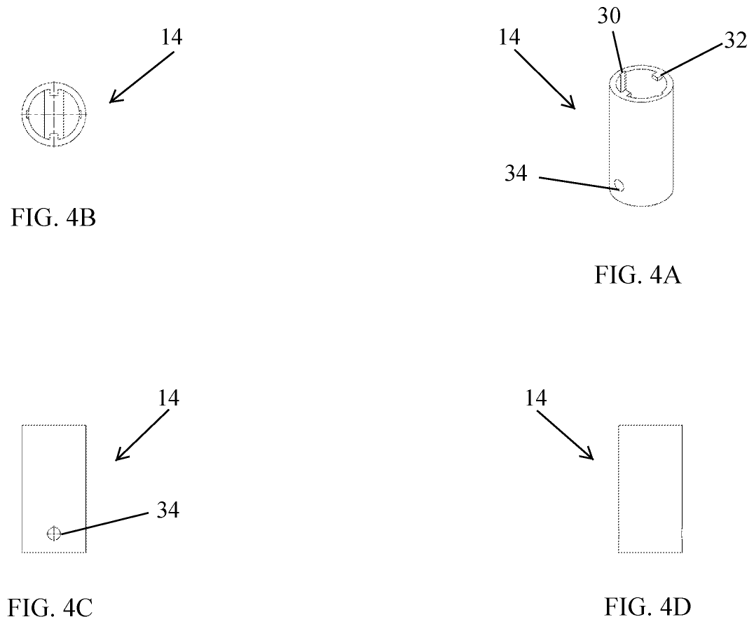

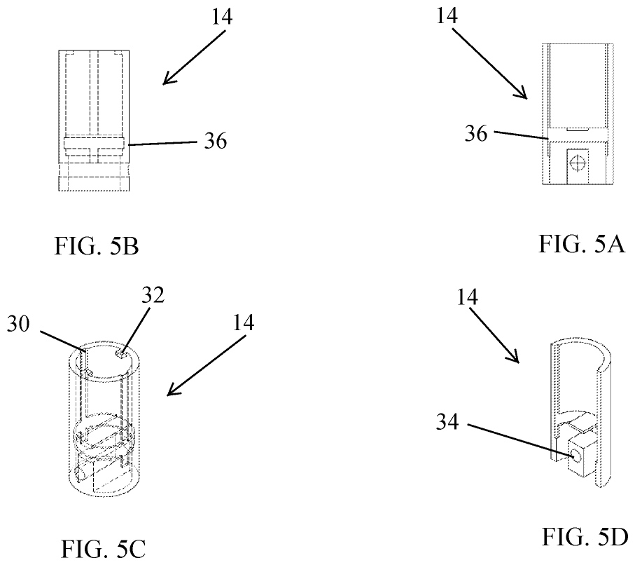

FIGS. 4A through 5D show the cylindrical shell that houses the support beam and connects with the wheel shaft. This part essentially serves as the connector that can transfer the force applied on the wheel to the connector beam, which is connected to the threaded shaft. The shell also has a circular depression on its inner side to house the locking ring between it and the support beam.

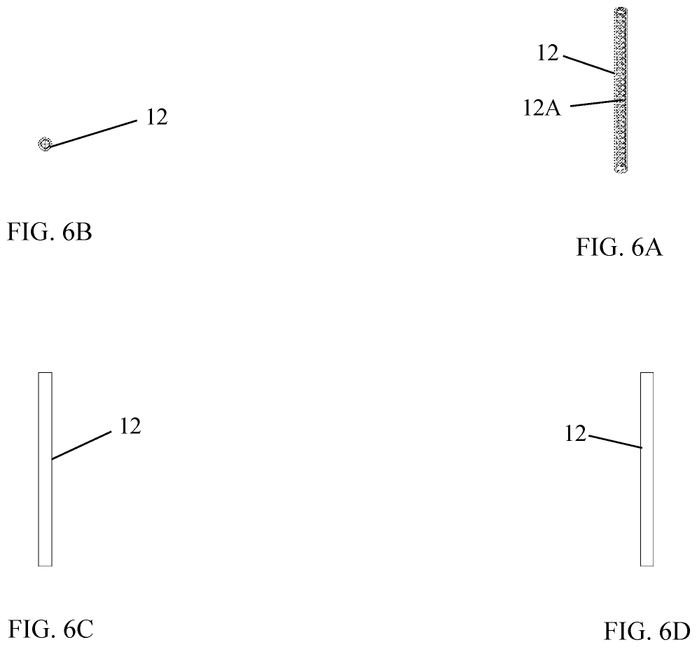

FIGS. 6A through 6D show the threaded shaft shell. This part can be powered by a motor in the mobile house to rotate along its axis to lower the support beam wheel assembly. Its vertical position relative to the mobile house can be fixed.

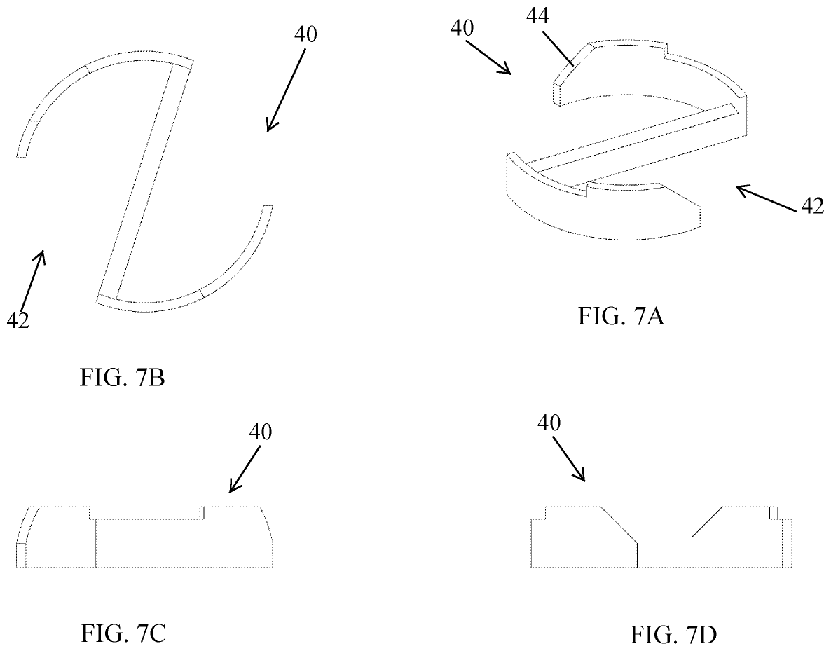

FIGS. 7A through 7D show the locking ring for the support beam. When the locking ring is engaged, the support beam and the shell that holds the wheel becomes one rigid body, and the normal force experienced by the wheels are supported by the support beam and threaded shaft. The edge of the locking ring is slightly angled to provide smoother descending motion of the support beam when unlocking.

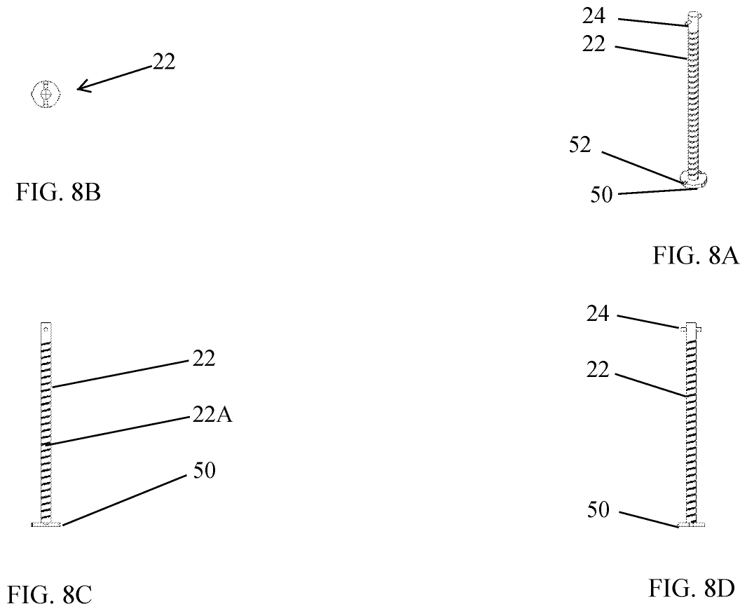

FIGS. 8A through 8D shows the threaded shaft that can be moved vertically when the threaded shell is rotated. The shaft cannot be rotated relative to the wall of mobile house to which it is attached. The top of the shaft can include a roller that can be slotted into a vertical rail inside the wall to prevent the threaded shaft from rotating on its axis. Two notches can be present on the top of the piston like part to help carry the cylindrical wheel shaft shell when the threaded shaft is being lifted upward.

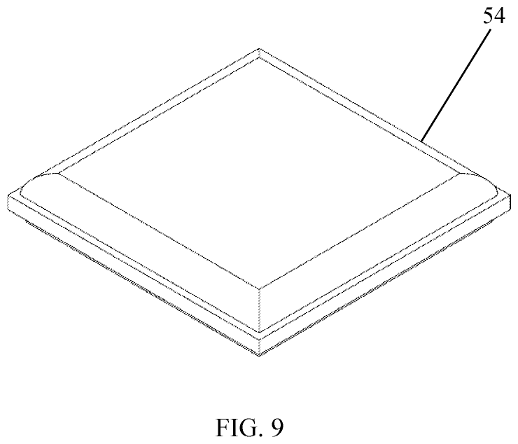

FIG. 9 shows the pressure sensor that can be placed between the threaded shaft and the support beam. The pressure sensor can gather data to achieve even support for the mobile house on uneven terrain.

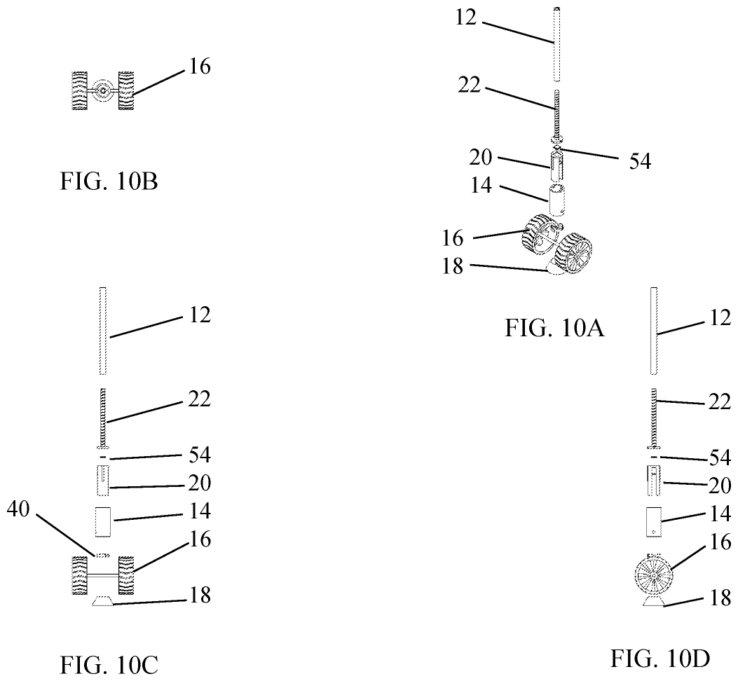

FIGS. 10A through 10D show an exploded view of the adaptive support, displayed for better understanding of the composition of the design.

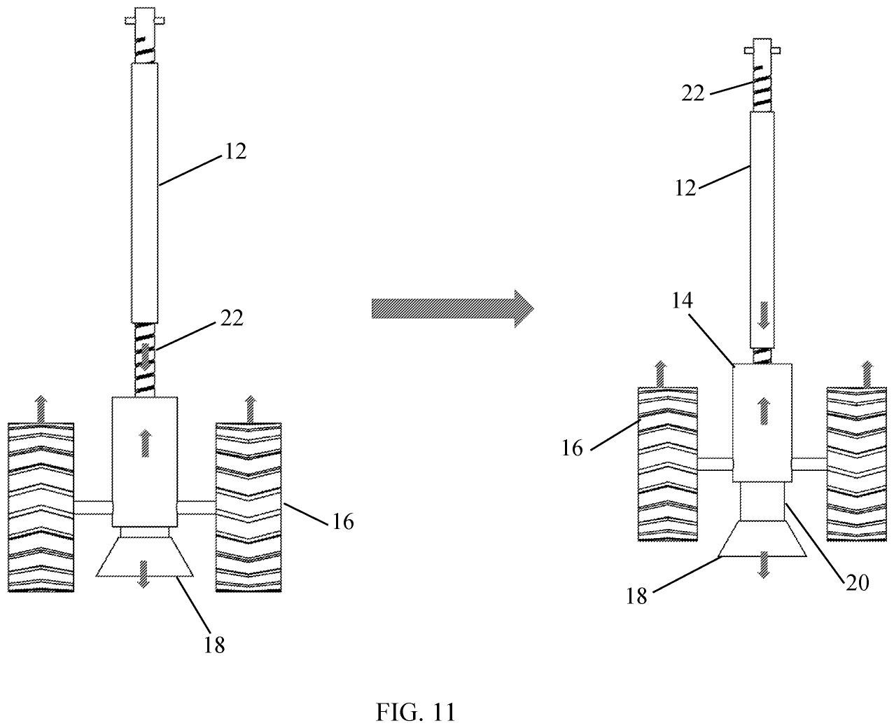

FIG. 11 shows how the support is lowered and the wheel is lifted when the mobile house finished its expansion, and the locking ring is disengaged.

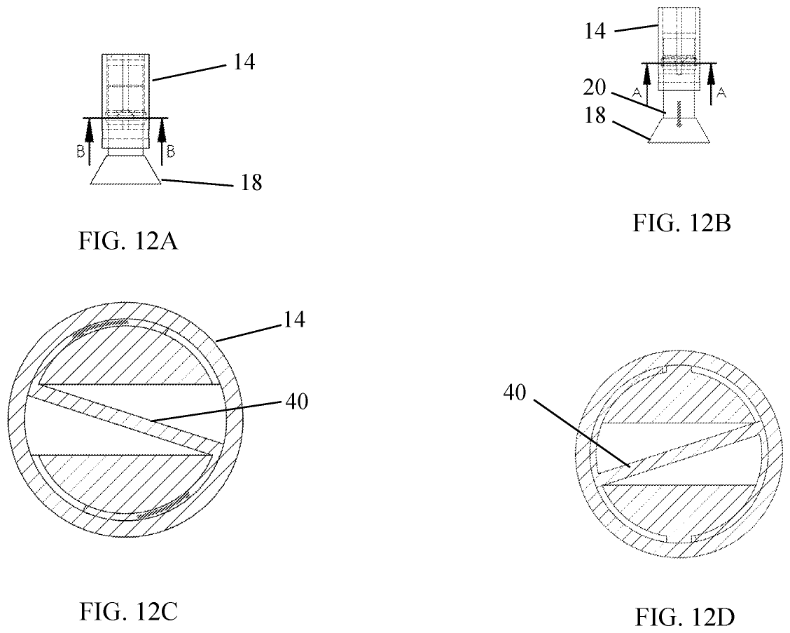

FIGS. 12A through 12D show the unlocking motion between the wheel shaft shell, the support beam, and the locking ring. When the support beam is locked, the ring is in a position on the wheel shell that blocks the extrusion on the sides of the support beam from being lowered. After the locking ring is turned, the support beam is unlocked, thus allowing it to be lowered. Before unlocking, all the normal force from the ground are being supported by the wheels. After unlocking, the wheels are free to move in the vertical direction, which means they no longer need to support normal force, and the force is being supported by the center beam.

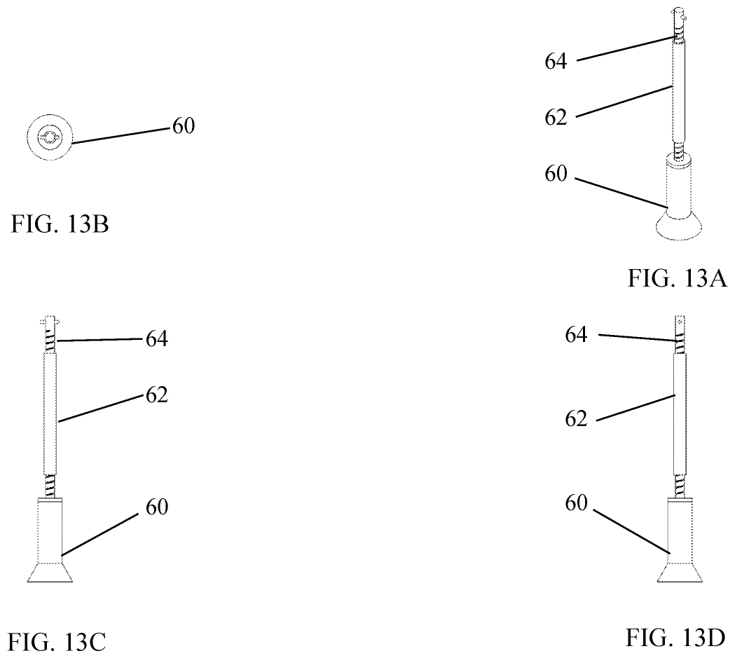

FIG. 13A through 13D show a support beam without wheels. Multiples of these support beams can be used as additional supports by the center of the mobile house near the chassis, for example. They can be lowered when the house is fully expanded and can be used in the terrain adapting system, described below. Together with the support beam that has wheels, they can provide support along with the chassis of the mobile house.

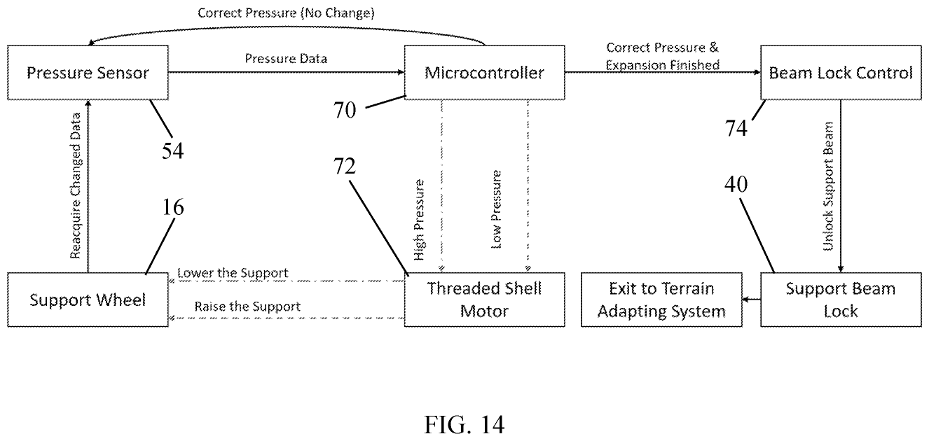

FIG. 14 is a block diagram of the electrical logistics of the support beam wheel if the wheels are passive components, which means they do not have motors and can only be moved by outer forces. This logistic is applied when the mobile house expands by using hydraulic rods or other methods to move the walls. When the mechanism is engaged as the expansion process starts, the pressure sensor can continuously send data to the microcontroller. The microcontroller uses the data to determine whether the pressure is high, low, or in the correct range. If the pressure is in the correct range, the microcontroller will not perform any action and continue to process the next data received. If the pressure is low or high, the microprocessor will send a command, depending on the pressure, to the motor of the threaded cylindrical shell. When the pressure is low, meaning the support is not holding all the weight of the wall, the threaded cylinder shell will be rotated, typically counterclockwise, to lower the beam or wheel so it can support more weight. When the pressure is high, meaning the support is lowered too much, the shell can be rotated, typically clockwise, to raise the beam. This program is kept running all throughout the expansion process, so adjustments can be made for any bump or change in terrain. This would allow the support to function not only on a flat terrain in an RV park but also uneven terrain out in the wilds.

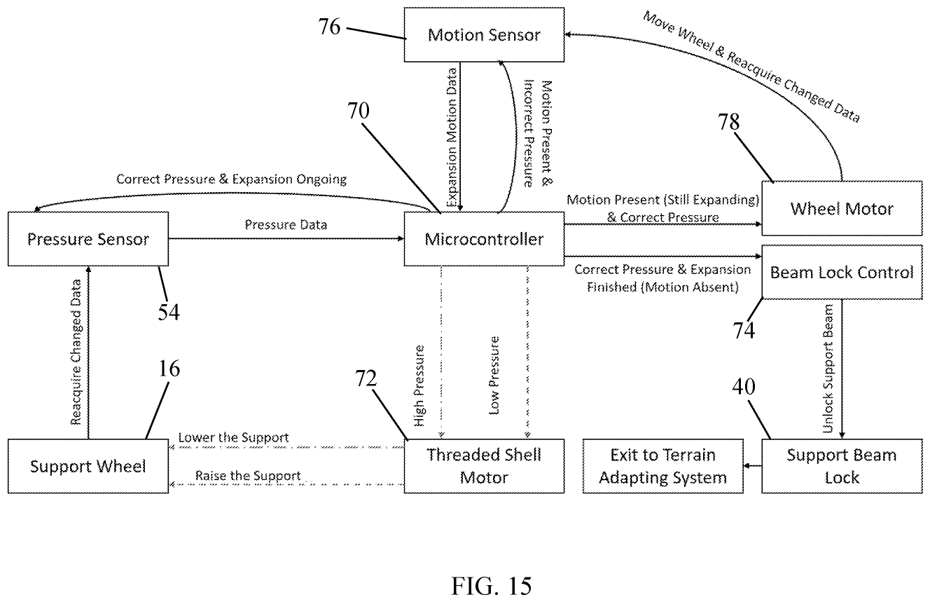

FIG. 15 is a block diagram of the support beam wheel electrical logistics if the wheels are active components, which means they have electric motors that powers them. This logistic is applied when the mobile house expands by using the wheels to move the walls. The only difference from the block diagram of FIG. 14, besides the wheel being active, is that the wheel and the expansion process will stop when the pressure is not in the correct range to allow the support beam to adjust its height before resuming the expansion process.

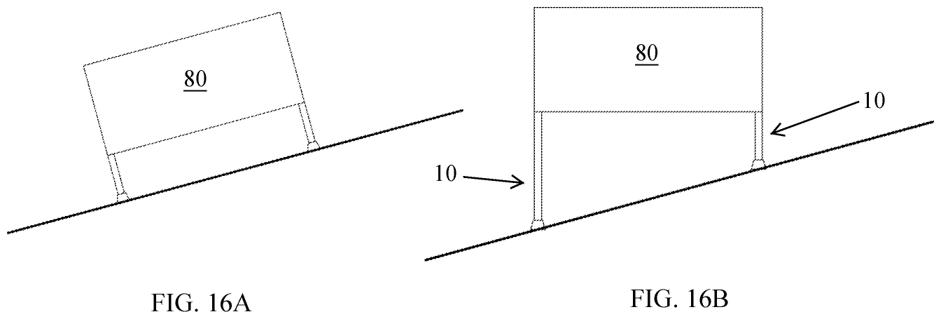

FIGS. 16A and 16B are two pictures that show use of the terrain adapting system. This system can use gyroscope sensors to detect which way the house is angled when on a slightly unlevel terrain. It can then raise the supports at the lower end to level the house.

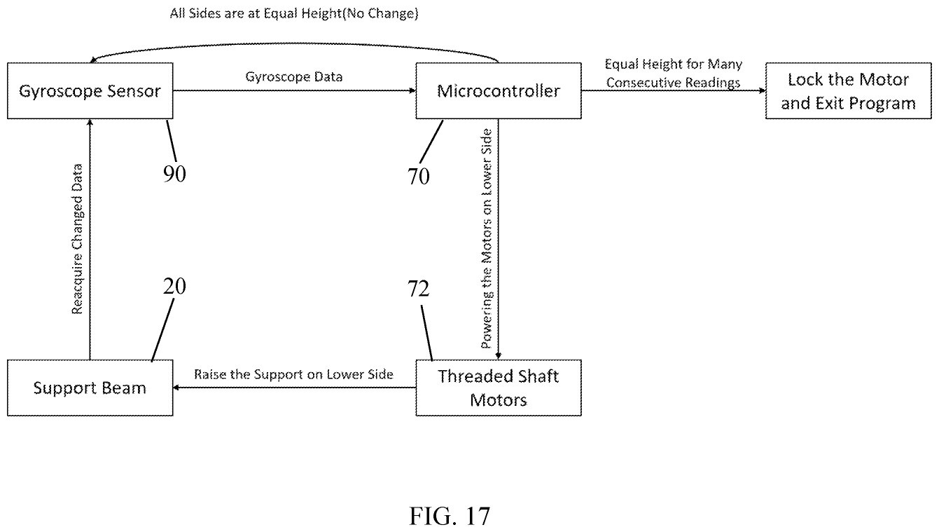

FIG. 17 is a block diagram of the operation of the terrain adapting support system. When the expansion process is finished and the terrain adapting system is activated, the system can activate and balance the mobile house on a slanted terrain. The system can take data from one or more gyroscope sensors on the mobile house and raise the height of the supports that is on the lower side. When the gyroscope senses the house is leveled, the supports will not be changed. After getting many consecutive readings that the house is leveled, the system can lock the motors.

Referring back to FIGS. 1A through 2B, a adapting support 10 can include a threaded shaft shell 12 having inside threads along at least a portion of an interior thereof. Typically, the threaded shaft shell 12 may be threaded along the entire length of the interior thereof. A threaded shaft 22 can have external threads 22A that mate with the internal threads 12A on the threaded shaft shell 12. A distal end of the threaded shaft 22 (distal relative to wheels 16 of the adapting support 10) can include pins 24 that can engage with a structure, such as an expansion section of a mobile house (not shown). The pins 24 can prevent rotation of the threaded shaft 22 relative to the mobile house. Accordingly, during use, the threaded shaft shell 12 may be rotated to cause the threaded shaft 22 to move the wheels 16 upward or downward, as the threaded shaft shell 12 may be vertically disposed in a vertically fixed position relative to the structure to which the adapting support 10 is attached.

The adapting support 10 can further include a beam shell 14 that houses a support beam 20 having an enlarged diameter support beam base 18. The support beam 20 may be unlocked to lower to contact a ground surface to provide support.

Referring to FIGS. 3A through 5D, the support beam 20 can include a protrusion 22 that can engage with a slot 30 on the beam shell 14 for preventing relative rotation between the beam shell 14 and the support beam 20. On top of the support beam 20, a location 38 is provided for placement of a pressure sensor 54 (see FIG. 9).

In some embodiments, the location 38 may be recessed into the top of the support beam 20 for secure placement of the support beam without movement thereof.

A slot 26 may be formed along opposing sides of the support beam 20 to permit the support beam 20 to move upward and downward without interference from an axle 38 connecting the wheels 16 (see FIG. 2A). Protrusions 32 may extend toward an interior of the beam shell 14, where the protrusions 32 may align with the slots 26 in the support beam 20 to permit relative sliding of the support beam 20 within the beam shell 14. The beam shell 14 can include a circular depression 36 along an inner side wall for placement of the lock ring 40, described below.

Referring now to FIGS. 7A through 7D, the lock ring 40 can be disposed in the circular depression 36 of the beam shell 14 and may be rotatable therein. To prevent the support beam 20 from lowering, the lock ring 40 may be positioned over the slot 30 of the beam shell 14, thus blocking the protrusion 24 of the support beam 20 from sliding down the slot 30. As the lock ring 40 is turned, a gap region 42, formed on opposite sides of the lock ring 40, can be positioned at the slot 30, thus permitting the support beam 20 to slide downward, with its protrusion 24 sliding down the now unblocked slot 30. The lock ring 40 may include a downward sloping surface 44 that permits the slower initial lowering of the beam support 20 as its protrusion 24 slides down the sloping surface 44 of the lock ring 40 before being freely slidable downward.

Referring to FIGS. 8A through 8D, the threaded shaft 22 can include a base member 50 that may have a bottom surface that can press against the pressure sensor 54 (see FIG. 9) that may be disposed on the top of the beam support 20, as described above. An upper surface of the base member may include a surface feature 52, such as a notch or an upward extending protrusion, that may engage with an undersurface of the top of the beam shell 14 to prevent relative rotation of the beam shell 14 with respect to the threaded shaft 22. Thus, the wheels 16 may be aligned with (and maintain such alignment) a direction of expansion or retraction of the mobile house expansion section.

Referring to FIGS. 11 through 12D, once the expansion section is expanded, the support beam 20 may be unlocked by rotation of the lock ring 40, as described above. The threaded shaft shell 12 may be rotated to lower the threaded shaft 22, that, accordingly, further lower the support beam 20, relieving pressure off the wheels 16.

Referring to FIGS. 13A through 13D, the wheels described above may be omitted when a non-moving support is needed. In this embodiment, a threaded shaft shell 62 may be turned to raise and lower a threaded shaft 64 having a support beam 60 attached thereto. In some embodiments, a pressure sensor may be used to properly turn the threaded shaft shell 62 to the proper support position, thus preventing over raising a portion of the expansion section of the mobile house and prevent under supporting the same portion of the expansion section.

Referring now to FIG. 14, the pressure sensor 54 can detect a pressure of the wheels 14 on the ground as the expansion section 80 (see FIGS. 16A and 16B) moves. The microcontroller 70 can receive data from the pressure sensor 54 and can drive a threaded shell motor 72 to move the threaded shaft shell 12 to adjust the position of the wheels 16, as described above. Once the expansion section is fully expanded, a beam lock controller 74 may turn the lock ring 40, as described above, to permit releases of the support beam 20. A similar function may be used to retract the expansion section, if desired.

Referring to FIG. 15, the functioning of the pressure sensor 54, microcontroller 70 and threaded shell motor 72 may be similar to that described above. In this embodiment, the wheels 16 may include a wheel motor 78 that may drive the wheels to move the expansion section. A motion sensor 76 can detect movement and stop the wheel motor 78 when the expansion section is fully expanded. Further, the motion sensor 76 may receive pressure data from the microcontroller 70. If there is too little pressure, the microcontroller 70 can stop the wheel motor 78 to prevent the wheels from turning without moving the expansion section due to inadequate pressure of the wheels on the ground.

In some embodiments, the microcontroller 70 may further include a terrain adapting system that may adjust the adapting supports 10 so that the expansion section 80 may be leveled, as shown in FIGS. 16A and 16B. FIG. 17 illustrates how a gyroscope sensor 90 may be used to provide data to the microcontroller 70 to adjust a position of the support beam 20 to level the expansion section. Once the expansion section is leveled, the microcontroller 70 may lock the motor to prevent any height change. Of course, the terrain adapting system may be disengaged with desired.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A support for a structure, comprising:
a rotatable internally threaded shell;
a threaded shaft having external threads mating with internal threads of the rotatable internally threaded shell;
one or more wheels supporting the threaded shaft; and
a pressure sensor operable to measure a force exerted on the threaded shaft by the structure, the pressure sensor operable to drive the rotatable internally threaded shell to maintain the measured force between a predetermined range while the support is moved along its one or more wheels.

2. The support of claim 1, further comprising a locking mechanism at a top end of the threaded shaft, the locking mechanism engaging with the structure to prevent relative rotation of the threaded shaft with respect to the structure.

3. The support of claim 2, wherein the locking mechanism includes one or more pins extending from upper edges of the threaded shaft.

4. The support of claim 1, further comprising:
a support beam receiving a lower end of the threaded shaft; and
a beam shell housing the support beam, the beam shell having a wheel axle passing therethrough.

5. The support of claim 4, wherein the support beam is fixed to the beam shell with a lock ring.

6. The support of claim 5, wherein turning the lock ring permits downward extension of the support beam relative to the beam shell.

7. The support of claim 5, further comprising:
a protrusion extending outward from an outside edge of the support beam; and
a slot formed vertically along an interior surface of the beam shell, wherein the protrusion is slidable along the slot when the lock ring is turned to an unlocked position; and
the protrusion is vertically retained with the lock ring is turned to a locked position, blocking movement of the protrusion along the slot.

8. The support of claim 5, wherein the lock ring is disposed in a circular groove cut in an interior of the beam shell.

9. The support of claim 1, further comprising a threaded shell motor operable to drive the threaded shaft shell.

10. The support of claim 9, further comprising a microcontroller receiving data from the pressure sensor, the microcontroller operable to control the threaded shell motor.

11. The support of claim 1, further comprising a wheel motor operable to drive the one or more wheels.

12. The support of claim 11, further comprising a motion sensor operable to detect motion of the structure and to control the wheel motor to stop when the structure is in a desired position.

13. The support of claim 12, further comprising a microcontroller receiving data from a pressure sensor, the microcontroller operable to stop the wheel motor when the measured force is below the predetermined range.

14. The support of claim 1, further comprising a terrain adapting system having a level sensor to detect if the structure is unlevel, wherein, when the structure is unlevel, the terrain adapting system adjusts the support to level the structure.

15. A support for a structure, comprising:
a rotatable internally threaded shell;
a threaded shaft having external threads mating with internal threads of the rotatable internally threaded shell;
a threaded shell motor operable to drive the rotatable internally threaded shell;
a pressure sensor operable to measure a force exerted on the threaded shaft by the structure; and
a microcontroller receiving data from the pressure sensor, the microcontroller operable to drive the rotatable internally threaded shell to maintain the measured force between a predetermined range.

16. The support of claim 15, further comprising one or more wheels supporting the threaded shaft.

17. The support of claim 15, further comprising:
a support beam receiving a lower end of the threaded shaft;
a beam shell housing the support beam, the beam shell having a wheel axle passing therethrough; and
a lock ring fixing the support beam to the beam shell, wherein
turning the lock ring permits downward extension of the support beam relative to the beam shell.

18. The support of claim 17, further comprising:
a protrusion extending outward from an outside edge of the support beam; and
a slot formed vertically along an interior surface of the beam shell, wherein the protrusion is slidable along the slot when the lock ring is turned to an unlocked position; and
the protrusion is vertically retained with the lock ring is turned to a locked position, blocking movement of the protrusion along the slot.

19. A support for a structure, comprising:
a rotatable internally threaded shell;
a threaded shaft having external threads mating with internal threads of the rotatable internally threaded shell;
one or more wheels supporting the threaded shaft;
a pressure sensor operable to measure a force exerted on the threaded shaft by the structure, the pressure sensor operable to drive the rotatable internally threaded shell to maintain the measured force between a predetermined range while the support is moved along its one or more wheels;
a support beam receiving a lower end of the threaded shaft;
a beam shell housing the support beam, the beam shell having a wheel axle passing therethrough; and
a lock ring fixing the support beam to the beam shell, wherein turning the lock ring permits downward extension of the support beam relative to the beam shell.

20. The support of claim 19, further comprising:
a protrusion extending outward from an outside edge of the support beam; and
a slot formed vertically along an interior surface of the beam shell, wherein the protrusion is slidable along the slot when the lock ring is turned to an unlocked position; and
the protrusion is vertically retained with the lock ring is turned to a locked position, blocking movement of the protrusion along the slot.
